(19) United States
(12) Patent Application Publication
(10) Pub. No.: US 2009/0102772 A1
(43) Pub. Date: Apr. 23, 2009

(54) IMAGE DISPLAY SYSTEM

(75) Inventors: Yi-Sheng YU, Taoyuan City (TW); Tsan-Hung Tsai, SanJhong City (TW); Yi-Chia Shan, Jhongli City (TW); Hsu-Pin Kao, Pingjhen City (TW)

Correspondence Address: Muncy, Geissler, Olds & Lowe, PLLC, P.O. BOX 1364, FAIRFAX, VA, 22038-1364, US

(73) Assignee: MARKETECH INTERNATIONAL CORP.

(21) Appl. No.: 12/059,928

(22) Filed: Mar. 31, 2008

(30) Foreign Application Priority Data
Oct. 17, 2007 (TW) 096138796

(51) Int. Cl. G09G 3/36

(52) U.S. Cl. 345/90

(57) ABSTRACT

The invention provides an image display system including a detection module, an adjusting module, and a display module. The display module includes a control unit and a panel. The detection module is used to determine whether an image signal includes a black stripe area. If the determination is true, the detection module will transmit out a control signal. The adjusting module is used to adjust a gray level of the black stripe area to a predetermined value. The control unit lowers the brightness corresponding to the black stripe area according to the control signal. The panel is used to display the image signal.

### BACKGROUND OF THE INVENTION

1. Field of the Invention

The invention relates to an image display system, and particularly to an image display system where there is a black stripe area in the image, capable of improving the image quality.

2. Description of the Prior Art

Image display techniques have been continually innovated and developed in recent years. There are many display apparatuses applied in different applications and having different functions that have become available in the market (for example, a plasma TV, a LCD, or a flat TV with a wide screen).

So far, an aspect ratio of a general flat TV is 16:9 (widescreen), so that an image shown on a TV screen can match the aspect ratio of a movie. However, when a user watches a movie displayed by a display apparatus, no matter the movie is displayed from a cable TV system or a DVD player, black stripe areas are often shown on both the top and the bottom of the screen as shown in FIG. 1A. Additionally, the black stripe areas could also be shown on the left and right side of the screen as shown in FIG. 1B.

Generally, because an aspect ratio of a movie is different from that of a TV screen, black stripe areas are shown on the image displayed by a TV screen. In respect of a display apparatus emphasizing on high quality images, black stripe areas can still have noises or a low gray level.

Therefore, the invention provides an image display system to solve the aforesaid problems.

### SUMMARY OF THE INVENTION

The invention provides an image display system, when there is a black stripe area in an image, capable of improving an image quality.

According to an embodiment, the image display system of the invention includes a detection module, an adjusting module, and a display module. The display module includes a control unit and a panel. The detection module is used to determine whether an image signal includes a black stripe area. If the image signal includes the black stripe area, the detection module will transmit out a control signal. The adjusting module is coupled to the detection module, and is used for adjusting a gray level of the black stripe area to a predetermined value. The control unit lowers the brightness corresponding to the black stripe area according to the control signal. The panel is coupled to the control unit, and is used for displaying the image signal.

Compared with prior art, the image display system of the invention can detect black stripe areas usually shown on the rims of a screen, and effectively lowers the brightness of the background light corresponding to the black stripe areas. Accordingly, the image display system of the invention can effectively improve a contrast of the displayed image, and reduces the electrical power consumption.

The advantage and spirit of the invention may be understood by the following recitations together with the appended drawings.

### BRIEF DESCRIPTION OF THE APPENDED DRAWINGS

FIG. 1A is a schematic diagram illustrating an image displayed on a screen with black stripe areas on both the top and bottom side.

FIG. 1B is a schematic diagram illustrating an image displayed on a screen with black stripe areas on both the left and right side.

FIG. 2 is a block function of an image display system according to an embodiment of the invention.

FIG. 3 is an example of a gray level driving processing of a plasma panel.

FIG. 4 is a block function of an image display system according to another embodiment of the invention.

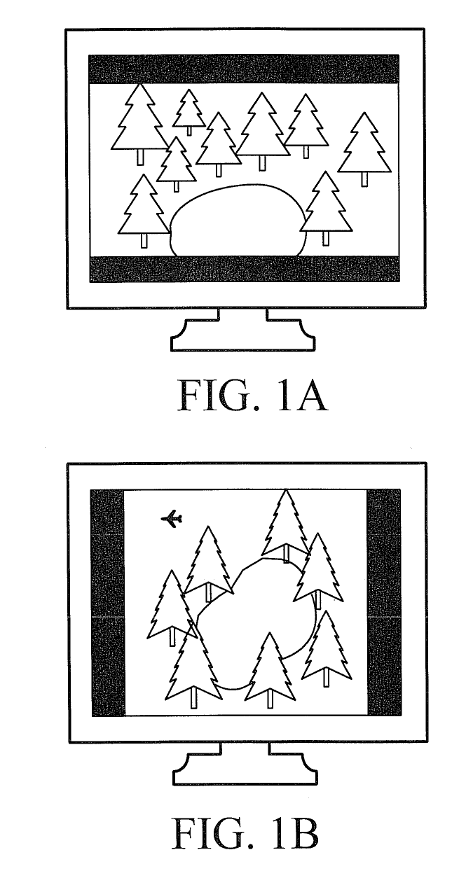

### DETAILED DESCRIPTION OF THE INVENTION

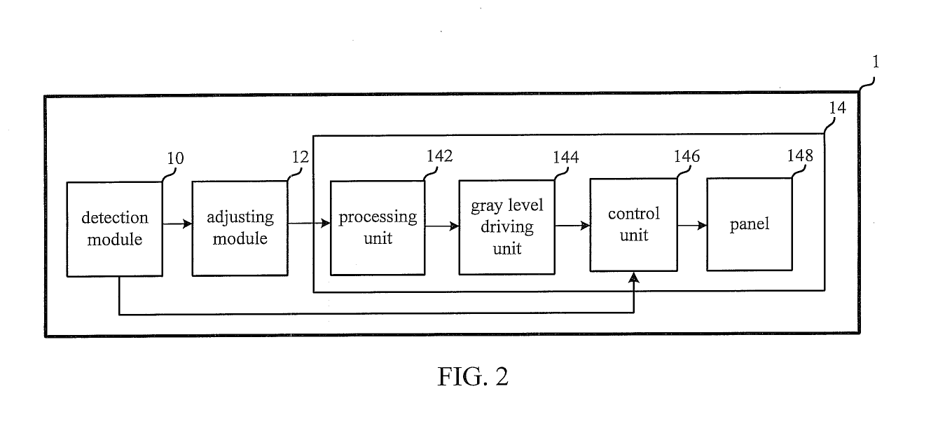

Please refer to FIG. 2. FIG. 2 is a block function of an image display system 1 according to an embodiment of the invention. As shown in FIG. 2, the image display system 1 includes a detection module 10, an adjusting module 12, and a display module 14. The display module 14 further includes a processing unit 142, a gray level driving unit 144, a control unit 146, and a panel 148.

The detection module 10 is used to determine whether an image signal includes a black stripe area. Generally, the black stripe area is shown on the top and/or bottom side of the panel, but it could also be shown on the left and/or right side of the panel depending on the aspect ratios of the image and panel. If the determination of the detection module 10 is true, the detection module 10 will transmits a control signal to the control unit 146.

The adjusting module 12 is coupled to the detection module 10, and is used for adjusting a gray level of the black stripe area to a predetermined value. In the embodiment, the predetermined value can be set as, but not limited to, 0. Afterward, the processing unit 142 performs a traditional image processing procedure on an image signal, the gray level driving unit 144 then performs a gray level driving procedure on the image signal. Then, the control unit 146 lowers the brightness corresponding to the black stripe area according to the control signal transmitted by the detection module 10. The panel 148 is coupled to the control unit 146, and is used for displaying the image signal.

In practical applications, the aforesaid panel 148 can be a plasma panel, a scanning backlight LCD panel, or a LED backlight LCD panel capable of controlling a regional brightness.

Take the panel 148 being a plasma panel for an example. A general plasma panel has to control millions of lighting-cells to independently light during a displaying time of one frame, so as to correctly display the gray level and brightness of the frame.

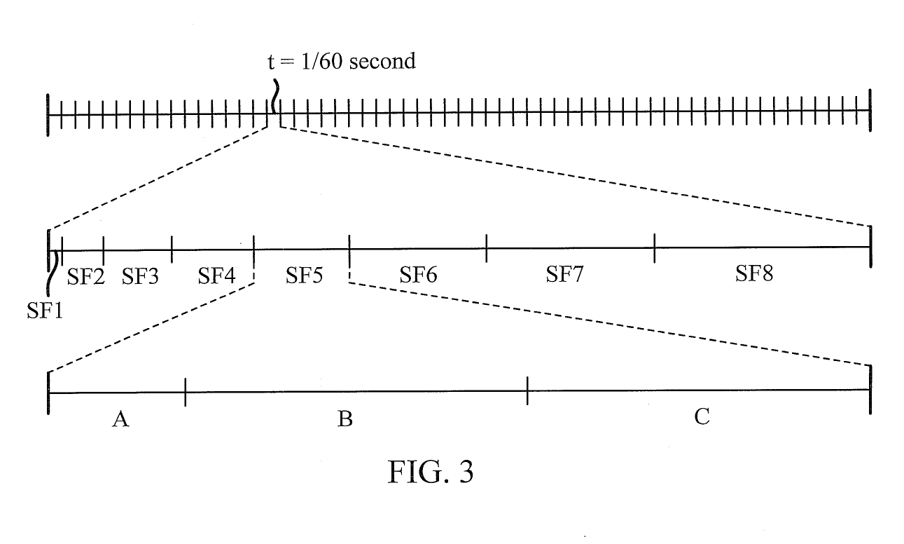

Please refer to FIG. 3. FIG. 3 is an example of a gray level driving processing of a plasma panel. In the example, the plasma panel can display 60 frames per second. As shown in FIG. 3, because the brightness of each lighting-cell of the plasma panel is relative to lighting times (pulsing times/numbers of electrodes), in order to correctly display the gray level of the frame, each 1/60 second is divided into several sub-fields with different time lengths during the gray level driving processing performed by the plasma panel. In the example, a display time t ( 1/60 second) of each frame is divided into eight sub-fields SF1˜SF8. Each of sub-fields has a different time length and a different pulse time/number, so the different brightness can be displayed. In each 1/60 second, each lighting-cell can display different gray level and brightness based on a composition of different sub-fields.

In order to correctly control millions lighting-cells of the panel in the time length of each sub-field, the time length of each sub-field can be further divided into three stages. For example, SF5 shown in FIG. 3 can be divided into an initial driving stage A, a scanning stage B, and a sustain discharging stage C.

When the gray level of the black stripe area is set as 0, the control signal transmitted by the detection module 10 can be used for controlling the control unit 146 to remove an initial driving signal, a scanning signal, or a sustain discharging signal corresponding to the black stripe area. Therein, the initial driving signal, the scanning signal, and the sustain discharging signal respectively correspond to the initial driving stage A, the scanning stage B, and the sustain discharging stage C. Procedures for removing the initial driving signal, the scanning signal, and the sustain discharging signal corresponding to the black stripe area are respectively described below in details.

In the initial driving stage A and the sustain discharging stage C, when the gray level of the black stripe area is set as 0, the control unit 146 can accept the control signal, so as to remove the initial driving signal or the sustain discharging signal corresponding to the black stripe area. Accordingly, the black stripe area will not have the background light, and the contrast of the image is improved. Additionally, the phenomenon of an electrical transmission and discharge will not occur, so the electrical power consumption can be reduced.

In the scanning stage B, because the plasma panel can be configured to scan nothing but a non-black stripe area, the scanning time can be saved, and the saved time can be used for the sustain discharging stage. When the control unit 146 accepts the control signal to remove the scanning signal corresponding to the black stripe area, the pulse times/numbers, discharging frequency, brightness, and contrast can be increased.

Next, that the panel 148 is a scanning backlight LCD panel or a display apparatus capable of controlling a regional brightness is discussed. These two display panels can have different brightness by controlling the backlights of different regions or by differential driving controlling on different regions. Therefore, performing processing procedure as the plasma panel, alternatively, when an image signal is determined including a black stripe area, a control signal is transmitted to the control unit 146, such that the brightness of the backlight of the black stripe area can be controlled. Accordingly, the display panel can highly save on the scanning time or regional control time; meanwhile, the electrical power consumption can also be reduced.

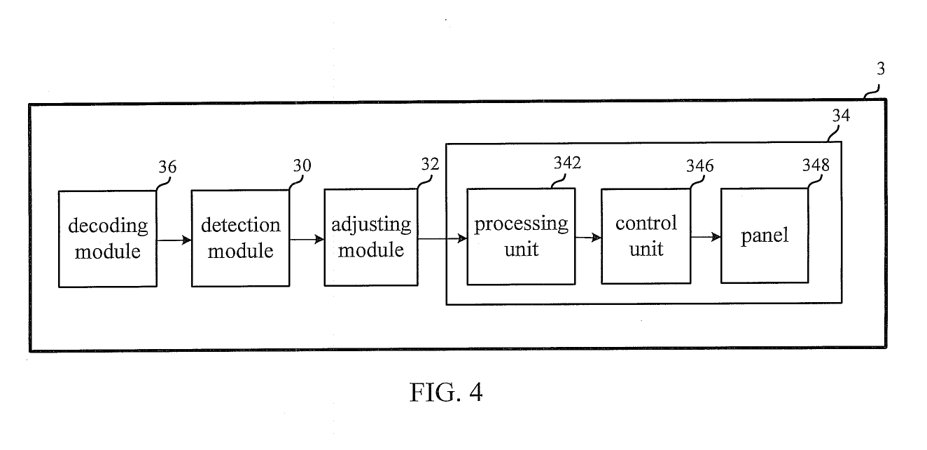

Please refer to FIG. 4. FIG. 4 is a block function of an image display system 3 according to another embodiment of the invention. As shown in FIG. 4, the image display system 3 includes a decoding module 36, a detection module 30, an adjusting module 32, and a display module 34. The decoding module 36 is used for decoding an image signal inputted into the image display system 3. The detection module 30 is coupled to the decoding module 36, and is used for determining whether the image signal includes a black stripe area. The adjusting module 32 is coupled to the detection module 30, and when the image signal includes a black stripe area, the adjusting module 32 is used for adjusting the gray level of the black stripe area to a predetermined value. In this embodiment, the predetermined value can be set as, but not limited to, 0. The display module 34 is coupled to the adjusting module 32, and is used for displaying the image signal. The display module 34 can further include a processing unit 342, a control unit 346, and a panel 348. At first, the processing unit 342 performs a traditional image processing procedure on the image signal. Afterward, the control unit 346 controls the panel 348 to display the image signal.

For example, if the image display system 3 is a general TV, a traditional processing procedure of a TV signal is described as follows. At first, the inputted image signal is decoded by the decoding module 36. Afterward, a traditional image processing procedure is performed on the image signal by the processing unit 342. At last, the control unit 346 controls the panel 38 to display the image signal.

The main difference of the signal processing procedure between the invention and prior art is that when the decoding module 36 decodes the inputted image signal, the detection module 30 will first determine whether the image signal includes a black stripe area. If the image signal includes the black stripe area, the adjusting module 32 will adjust the gray level of the black stripe area to 0 (the predetermined value). The afterward steps follow the traditional processing procedure of a TV signal. Accordingly, the black stripe area will not have the background light, so as to improve the contrast of the image. Meanwhile, noises generated on the black stripe area can be reduced, so as to improve on the image quality.

Compared with prior art, the image display system of the invention can detect black stripe areas that are usually shown on the rims of the TV screen, and effectively lowers the brightness of the background light of the black stripe areas. Therefore, the contrast of the displayed image can be effectively improved, and the electrical power consumption can be reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An image display system, comprising:
a detection module, for determining whether an image signal comprises a black stripe area, if YES, the detection module transmitting out a control signal;
an adjusting module coupled to the detection module, for adjusting a gray level of the black stripe area to a predetermined value; and
a display module coupled to the detection module and the adjusting module respectively, comprising:
a control unit, for lowering a brightness corresponding to the black stripe area according to the control signal; and
a panel coupled to the control unit, for displaying the image signal.

2. The image display system of claim 1, wherein the display module further comprises a processing unit coupled between the adjusting module and the control unit, for performing an image processing procedure on the image signal.

3. The image display system of claim 1, wherein the predetermined value can be set as 0.

4. The image display system of claim 1, wherein the panel is a plasma panel, and the control signal is used for controlling the control unit to remove an initial driving signal, a sustain discharging signal, or a scanning signal corresponding to the black stripe area.

5. The image display system of claim 1, wherein the panel is a scanning backlight LCD panel or a display apparatus capable of controlling a regional brightness.

6. The image display system of claim 1, wherein the black stripe area is displayed on a rim of the panel.

7. An image display system, comprising:
a decoding module, for decoding an image signal;
a detection module coupled to the decoding module, for determining whether the image signal comprises a black stripe area;
an adjusting module coupled to the detection module, when the image signal comprises the black stripe area, the adjusting module adjusting a gray level of the black stripe area to a predetermined value; and
a display module coupled to the adjusting module, for displaying the image signal.

8. The image display system of claim 7, wherein the predetermined value can be set as 0.

9. The image display system of claim 7, wherein the display module comprises:
a processing unit, for proceeding an image processing procedure on the image signal;
a panel; and
a control unit coupled between the processing unit and the panel, for controlling the panel to display the image signal.

10. The image display system of claim 9, the black stripe area is displayed on a rim of the panel.
